(19) United States
(12) Patent Application Publication
(10) Pub. No.: US 2026/0347186 A1
(43) Pub. Date: Nov. 5, 2026

(54) BORON NITRIDE POWDER AND RESIN COMPOSITION

(71) Applicant: Denka Company Limited, Tokyo (JP)

(72) Inventors: Mana YAMAMOTO, Chuo Tokyo (JP); Kenji MIYATA, Chuo Tokyo (JP); Yusuke SASAKI, Chuo Tokyo (JP); Ryoh EBISUZAKI, Chuo Tokyo (JP)

(21) Appl. No.: 19/107,543

(22) PCT Filed: Aug. 22, 2023
(86) PCT No.: PCT/JP2023/030197

§ 371 Date: Feb. 27, 2025

(30) Foreign Application Priority Data
Aug. 30, 2022 (JP) 2022-137087

(51) Int. Cl. C01B 21/064; C08K 3/38

(52) U.S. Cl. CPC C01B 21/064; C08K 3/38; C01P 2002/72; C01P 2006/14; C01P 2006/17; C08K 2003/385

(57) ABSTRACT

A boron nitride powder contains boron nitride particles having pores. In a differential pore volume curve with respect to pore radius measured by a mercury porosimeter, within the range where the pore radius is 1.2 μm or less, the slope of a straight line connecting the point where the differential pore volume curve rises and the point where the differential pore volume reaches its maximum value is 0.8 or less.

### TECHNICAL FIELD

The present invention relates to a boron nitride powder and a resin composition.

### BACKGROUND ART

Boron nitride has lubricity, high thermal conductivity, and insulating properties, and is used for various applications such as solid lubricants, mold release materials, raw materials for cosmetics, heat dissipation materials, and insulating sintered bodies having heat resistance.

For example, Patent Literature 1 discloses a hexagonal boron nitride powder that can provide high thermal conductivity and high dielectric strength to a resin composition obtained by filling it to a resin, in which hexagonal boron nitride powder contains aggregated particles composed of primary particles of hexagonal boron nitride, a BET specific surface area thereof is 0.7 to 1.3 m²/g and an oil absorption amount thereof measured based on JIS K 5101-13-1 is 80 g/100 g or less.

### CITATION LIST

### Patent Literature

Patent Literature 1: Japanese Unexamined Patent Publication No. 2016-160134

### SUMMARY OF INVENTION

### Technical Problem

A main object of the present invention is to provide a novel boron nitride powder.

### Solution to Problem

According to aspects of the present invention, the following [1] to [5] are provided.
[1]A boron nitride powder containing boron nitride particles having pores, wherein in a differential pore volume curve with respect to pore radius measured by a mercury porosimeter, within the range where the pore radius is 1.2 μn or less, the slope of a straight line connecting the point where the differential pore volume curve rises and the point where the differential pore volume reaches its maximum value is 0.8 or less.
[2] The boron nitride powder according to [1], in which the integrated pore volume in a pore-radius range of 1.2 μm or less is 0.2 ml/g or less.
[3] The boron nitride powder according to [1] or [2], in which the maximum value is 0.4 ml/g or less.
[4] The boron nitride powder according to any one of [1] to [3], in which the maximum value is 0.1 ml/g or more.
[5]A resin composition containing the boron nitride powder according to any one of [1] to [4] and a resin.

### Advantageous Effects of Invention

According to an aspect of the present invention, it is possible to provide a novel boron nitride powder.

### BRIEF DESCRIPTION OF DRAWINGS

FIG. 1 is a graph showing X-ray diffraction measurement results of a boron nitride powder obtained in Example 1.

FIG. 2 is a pore-size distribution of a boron nitride powder obtained in Example 1.

FIG. 3 is a pore-size distribution of a boron nitride powder obtained in Example 2.

FIG. 4 shows a pore-size distribution of a boron nitride powder obtained in Example 3.

FIG. 5 shows a pore-size distribution of a boron nitride powder obtained in Comparative Example 1.

### DESCRIPTION OF EMBODIMENTS

Hereinafter, embodiments of the present invention will be described in detail.

The boron nitride powder according to the present embodiment contains boron nitride particles having pores, and may be an aggregate of a plurality of boron nitride particles (boron nitride particles having pores).

Each of plural boron nitride particles is constituted of, for example, a plurality of boron nitride pieces. The pores of the boron nitride particles may be formed among the plural boron nitride pieces. The boron nitride piece is formed of boron nitride, and may have, for example, a scale-like shape.

The plural boron nitride pieces may be in physical contact with each other or may be chemically bonded to each other. The chemical bonding of the plural boron nitride pieces can be confirmed by the fact that no boundary is observed by an SEM in the bonding portion between the boron nitride pieces.

The boron nitride particle may have across section having a region where a plurality of boron nitride pieces are laminated. The fact that the plural boron nitride pieces are laminated can be confirmed by SEM observation of the cross section of a boron nitride particle, based on the appearance where the plural boron nitride pieces are arranged in tandem in the thickness direction.

The average thickness of the boron nitride pieces may be 0.5 μm or more, 1 μm or more, or 1.5 μm or more, and may be 5 μm or less. The average length of the boron nitride pieces in the longitudinal direction may be, for example, 1 μm or more and 10 μm or less. The average thickness and the average length in the longitudinal direction of the boron nitride pieces are defined as an average value of the thicknesses and an average length in the longitudinal direction of 40 boron nitride pieces, which are determined by loading SEM images of cross sections of boron nitride particles observed by an SEM at a magnification of 1000 times into image analysis software (for example, “Mac-view” manufactured by Mountech Co., Ltd.) followed by measuring in the SEM images.

The boron nitride particles may substantially consist of boron nitride alone. The fact that the boron nitride particles substantially consist of boron nitride alone can be confirmed by detecting only a peak derived from boron nitride in X-ray diffraction measurement.

The boron nitride powder has a maxim μm value (peak) within the range where the pore radius is 1.2 μm or less in the differential pore volume curve (horizontal axis: pore radius, vertical axis: differential pore volume) measured using a mercury porosimeter. The maximum value is such that the slope of the straight line connecting the point where the differential pore volume curve rises and the point where the differential pore volume reaches its maximum value is 0.8 or less.

More specifically, in the differential pore volume curve with respect to the pore radius, provided that the differential pore volume at a point where the differential pore volume curve rises in a pore-radius range of 1.2 μm or less is represented by V₁ (ml/g), the pore radius at a point where the differential pore volume is V₁ is represented by R₁ (μm), the differential pore volume at a point where the differential pore volume reaches a maximum value is represented by V₂ (ml/g), and the pore radius at a point where the differential pore volume is a maximum value V₂ is represented by R₂ (μm), a slope a represented by the following Formula (1) is 0.8 or less.

a=(V₂−V₁/(R₂−R₁) (1)

When the boron nitride powder exhibits a peak having a slope of the straight line (slope a represented by the above Formula (1)) of 0.8 or less in the differential pore volume curve with respect to the pore radius, results in each boron nitride particle in the boron nitride powder has few pores with a small pore radius, with the result that the volume of voids present within the particles also decreases. Therefore, the boron nitride powder contains dense boron nitride particles, and when such boron nitride powder is mixed with, for example, a resin and used as a thermal conductive material (for example, a heat dissipation material), the boron nitride powder can exhibit high thermal conductivity compared to conventional boron nitride powders.

The differential pore volume curve with respect to pore radius is obtained based on the mercury intrusion technique using a mercury porosimeter and in accordance with JIS R1655:2003. The differential pore volume curve is obtained by the following procedure. Specifically, first, the differential pore volume with respect to a pressure in the range of 0.40 to 60,000 psia is measured by a mercury porosimeter. At this time, the logarithmic value of the pressure is plotted on the horizontal axis and the differential pore volume is plotted on the vertical axis to make a logarithmic graph. In the logarithmic graph, 130 pressure values at which a differential pore volume is measured are marked at equal intervals on the horizontal axis. Then, the pressure value is converted to the pore radius, and thereafter the measured differential pore volume with respect to the logarithmic value of the converted pore radius is plotted, and then the plots are connected by a straight line to obtain a differential pore volume curve with respect to the pore radius.

The point where the differential pore volume curve rises is defined as the point where the differential pore volume is 0.02 ml/g. That is, the differential pore volume V₁ in Formula (1) is 0.02 ml/g, and the pore radius R₁ is the pore radius when the differential pore volume is 0.02 ml/g. Since in the range of the differential pore volume of less than 0.02 ml/g, the effect of noise on measurement is large, a point where the differential pore volume is 0.02 ml/g is defined as a point where the differential pore volume curve rises. Note that, when there are a plurality of points at which the differential pore volume is 0.02 ml/g in the pore-radius range of 12 μm or less, a point exhibiting the smallest pore radius among the plural points is defined as a point where the differential pore volume curve rises.

The maximum value (peak) of the differential pore volume is defined as a measurement point where a change of the differential pore volume goes from a positive value to a negative value as the value of pore radius increases in the differential pore volume curve with respect to the pore radius. That is, of the measurement points of the differential pore volume, in the (m−1)-th measurement point (pore radius: Rₘ₋₁, (μm), differential pore volume: Vₘ₋₁ (ml/g)), the m-th measurement point (pore radius: Rₘ (μm), differential pore volume: Vₘ (ml/g)), and the (m+1)-th measurement point (pore radius: Rₘ₋₁ (μm), differential pore volume: Vₘ₊₁ (ml/g)), the m-th measurement point satisfying Rₘ₋₁<Rₘ<Rₘ≤Rₘ₊₁, and Vₘ−Vₘ₋₁>0 and Vₘ₊₁−Vₘ<0 is defined as the point where the differential pore volume has a maximum value. In the case of Vₘ₊₁=Vₘ, in the (m+n)-th measurement point (pore radius: Rₘ₊ₙ(μm), differential pore volume: Vₘ₊ₙ (ml/g), the smallest integer of n: 2 or more and satisfying Vₘ≠Vₘ₊ₙ), the m-th measurement point satisfying Rₘ₋₁<Rₘ<Rₘ₊ₙ, Vₘ−Vₘ₋₁>0 and Vₘ₊ₙ−Vₘ<0 is defined as the point where the differential pore volume has a maximum value. Note that, in the case that a plurality of points where the differential pore volume has a maximum value are present in the pore-radius range is 1.2 μm or less, a point having the smallest pore radius of the plural points is defined as the point where the differential pore volume has a maximum value.

The pore radius R₁ may be 0.01 μm or more, 0.02 μm or more, 0.04 μm or more, 0.05 μm or more, or 0.06 μm or more, and may be 0.3 μm or less, 0.2 μm or less, 0.15 μm or less, 0.13 μm or less, 0.12 μm or less, or 0.11 μm or less.

The maximum value V₂ may be 0.4 ml/g or less, 0.35 ml/g or less, 0.32 ml/g or less, 0.3 ml/g or less, 0.28 ml/g or less, or 0.26 ml/g or less, and may be 0.1 ml/g or more, 0.15 ml/g or more, 0.19 ml/g or more, or 0.2 ml/g or more.

The pore radius R₂ may be 0.2 μm or more, 0.3 μm or more, 0.4 μm or more, 0.5 μm or more, or 0.6 μm or more, and may be 1.1 μm or less, 1 μm or less, 0.9 μm or less, 0.8 μm or less, or 0.7 μm or less.

The slope of the straight line (slope a represented by Formula (1)) may be 0.7, or less, 0.6 or less, or 0.5 or less, and may be 0.1 or more, 0.2 or more, 0.3 or more, or 0.35 or more.

The differential pore volume curve with respect to the pore radius may be a curve showing a gradual change (decrease) of the differential pore volume in the range from the pore radius R₂ at which the differential pore volume has the maximum value V₂ to the pore radius of 1.2 μm. Specifically, provided that a minimum value of the differential pore volume in the range from the pore radius R₂ at which the differential pore volume exhibits a maximum value V₂ to the pore radius of 1.2 μm is represented as V₃ (ml/g), and the pore radius at which the differential pore volume exhibits a minimum value V₃ is represented as R₃ (μm), the slope b==(V₂−V₃)/(R₂−R₃) of the straight line connecting the maximum value V₂ and the minimum value V₃ may be −0.01 or less, −0.04 or less, or −0.05 or less, and may be −0.5 or more, −0.4 or more, −0.3 or more, −0.2 or more, or −0.1 or more.

The integrated pore volume of the boron nitride powder in a range in which a pore radius measured by a mercury porosimeter is 1.2 μm or less may be 0.2 ml/g or less, 0.19 ml/g or less, or 0.18 ml/g or less. Since the integrated pore volume in the pore-radius range of the boron nitride powder of 1.2 μm or less can be regarded as the total amount of voids in each boron nitride particle constituting the boron nitride powder, the smaller the integrated pore volume in the pore-radius range of 1.2 μm or less, the denser the boron nitride particles tend to be. For this reason, when such boron nitride particles are mixed with a resin to prepare a heat dissipation material, the filling rate of the boron nitride particles is increased even if the boron nitride particles are not crashed, and a heat dissipation material having high thermal conductivity is easily obtained. The integrated pore volume in the pore-radius range measured by a mercury porosimeter is 1.2 μm or less may be 0.1 ml/g or more, 0.12 ml/g or more, 0.14 ml/g or more, 0.15 ml/g or more, 0.16 ml/g or more, or 0.17 ml/g or more.

The integrated pore volume of the boron nitride powder in the pore radius range of 500 in or less measured by a mercury porosimeter may be 1 ml/g or less, 0.95 ml/g or less, or 0.91 ml/g or less. The integrated pore volume may be 0.7 mil/g or more, 0.8 ml/g or more, 0.85 ml/g or more, 0.88 ml/g or more, or 0.9 ml/g or more.

The bulk density of the boron nitride powder may be 0.7 g/ml or more, 0.72 g/ml or more, 074 g/ml or more, or 0.75 g/ml or more, and may be 0.9 g/ml or less, 0.8 g/ml or less, or 0.75 g/ml or less.

The average particle size of the boron nitride powder may be, for example, 10 μm or more, 20 μm or more, or 30 μm or more, and may be 100 μm or less, 80 μm or less, or 60 μm or less. The average particle size of the boron nitride powder refers to a particle size (D50) at which a volume cumulative particle-size distribution is 50%, and can be determined by a laser diffraction scattering method.

The BET specific surface area of the boron nitride powder can be measured by a BET multipoint method using nitrogen gas in accordance with JIS Z 8830:2013. The BET specific surface area of the boron nitride powder may be 1 m²/g or more, 2 m²/g or more, or 2.5 m²/g or more, and may be 5 m²/g or less, 4 m/g or less, or 3.5 m²/g or less.

A method for producing the boron nitride powder will be described below. The boron nitride powder can be produced, for example, by a method including a step (nitriding step) of nitriding boron carbide particles by hot isostatic press (also referred to as “hot isostatic pressing”) to obtain boron carbonitride particles and a step (decarburization step) of decarburizing the boron carbonitride particles to obtain a boron nitride powder containing the boron nitride particles. That is, another embodiment of the present invention is a method for producing such a boron nitride powder. The method for producing the boron nitride particles is not limited to the above method.

The boron carbide particles can be produced, for example, by a commonly known production method. Examples thereof include a method of obtaining massive boron carbide particles by mixing boric acid and acetylene black followed by heating at 1800 to 2400 °C for 1 to 10 hours in an inert gas atmosphere. The massive boron carbide particles obtained by this method may be appropriately subjected to, for example, grinding, sieving, washing, impurity removal, and drying. The average particle size of the boron carbide particles may be, for example, 5 μm or more, 10 μm or more, or 15 μm or more, and may be 80 μm or less, 60 μm or less, or 40 μm or less. The average particle size of the boron carbide particles refers to a particle size (D50) at which a volume cumulative particle-size distribution is 50%, and can be determined by a laser diffraction scattering method.

In the nitriding step, boron carbonitride boron particles are obtained by nitriding boron carbide particles by filling the boron carbide particles in a container, followed by heating while performing hot isostatic pressing under an atmosphere facilitating a nitriding reaction. The container may be, for example, a crucible made of carbon. The hot isostatic pressing can be performed using, for example, a hot isostatic pressing apparatus (for example, manufactured by Kobe Steel, Ltd.).

The atmosphere in which a nitriding reaction proceeds in the nitriding step may be a gas nitriding boron carbide particles. The nitriding gas may be, for example, nitrogen gas or ammonia gas, and in view of facilitating nitriding boron carbide particles and cost, maybe nitrogen gas. The nitriding gases may be used alone or in combination of two or more types, and the ratio of the nitrogen gas in the nitriding gas may be 95 vol % or more, 99 vol % or more, or 99.9 vol % or more.

The pressure in the nitriding step may be 50 MPa or more, 70 MPa or more, or 100 MPa or more. The pressure in the nitriding step may be 200 MPa or less or 150 MPa or less.

The heating temperature in the nitriding step may be 1600 °C or more or 1700 °C or more in order to sufficiently nitride the boron carbide particles. The heating temperature in the nitriding step may be 2200 °C or less or 2000 °C or less.

The time required for pressurization and heating in the nitriding step may be 30 minutes, 45 minutes or more, or 1 hour or more in order to sufficiently nitride the boron carbide particles. The time for pressurization and heating in the nitriding step may be 30 hours or less, 20 hours or less, or 10 hours or less.

In the decarburization step, the boron carbonitride particles are decarburized by filling a mixture of the boron carbonitride particles obtained in the nitriding step and a boron source in a container, followed by heating. The container may be, for example, a crucible made of boron nitride.

Examples of the boron source include boric acid, boron oxide, and a mixture thereof. The mixture may further contain other additives used as necessary in the technical field to which the present invention pertains. The mixing ratio of the boron carbonitride particles and the boron source is appropriately selected. When boric acid or boron oxide is used as the boron source, the ratio of boric acid or boron oxide may be, for example, 50 parts by mass or more or 80 parts by mass or more, and 300 parts by mass or less or 200 parts by mass or less relative to 100 parts by mass of boron carbonitride.

The atmosphere in the decarburization step may be a normal-pressure (atmospheric pressure) atmosphere or a pressurized atmosphere.

The pressure in the decarburization step may be, for example, 0.5 MPa or less or 0.3 MPa or less, and may be 0.01 Pa or more or 0.03 MPa or more.

In the decarburization step, for example, first, the temperature is raised to a predetermined temperature (temperature at which decarburization can start), and then the temperature is further raised from the predetermined temperature to a retention temperature. The predetermined temperature (temperature at which decarburization can started) may be, for example, 1000 °C or more and 1500 °C or less or 1200 °C or less. The rate of raising temperature from the predetermined temperature (temperature at which decarburization can start) to the retention temperature may be, for example, 5 °C/min or less, 4 °C/min or less, 3 °C/min or less, or 2 °C/min or less.

The retention temperature may be 1800 °C or more or 2000 °C or more in order for particle growth to satisfactorily start. The retention temperature may be 2200 °C or less or 2100 °C or less.

The retention time at the retention temperature may be, for example, 0.5 hours or more, 1 hour or more, 3 hours or more, or 5 hours or more in order for particle growth to satisfactorily start. The retention time at the retention temperature may be, for example, 40 hours or less, 30 hours or less, or 20 hours or less.

The boron nitride particles (boron nitride powder) obtained as described above may be subjected to a step (classification step) of classifying by a sieve so as to obtain a boron nitride powder having a desired particle size.

The boron nitride powder described above is suitably used for, for example, a heat dissipation member. When used for a heat dissipation member, the boron nitride powder is mixed with, for example, a resin and used as a resin composition. That is, another embodiment of the present invention is a resin composition containing a resin and the boron nitride powder.

The content of the boron nitride powder may be 50 vol % or more, 55 vol % or more, 60 vol % or more, 65 vol % or more, or 70 vol % or more based on the total volume of the resin composition in order to improve the thermal conductivity of the resin composition and easily obtain excellent heat dissipation performance. The content of the boron nitride powder may be 85 vol % or less, 80 vol % or less, or 75 vol % or less based on the total volume of the resin composition in order to suppress generation of pores during molding and a decrease in insulating properties and mechanical strength.

Examples of the resin include epoxy resin, silicone resin, silicone rubber, acrylic resin, phenol resin, melamine resin, urea resin, unsaturated polyester, fluororesin, polyimide, polyamideimide, polyetherimide, polybutylene terephtalate, polyethylene terephthalate, polyphenylene ether, polyphenylene sulfide, wholly aromatic polyester, polysulfone, liquid crystal polymer, polyethersulfone, polycarbonate, maleimide-modified resin, acrylonitrile-butadiene-styrene (ABS) resin, acrylonitrile-acrylic-styrene (AAS) resin, and acrylonitrile-ethylene-propylene-diene rubber-styrene (AES) resin.

The content of the resin may be 15 vol % or more, 20 vol % or more, or 25 vol % or more, and may be 50 vol % or less, 45 vol % or less, 40 vol % or less, 35 vol % or less, or 30 vol % or less based on the total volume of the resin composition.

The resin composition may further contain a curing agent for curing a resin. The curing agent is appropriately selected depending on the type of resin. For example, in a case where the resin is an epoxy resin, examples of the curing agent include a phenol novolak compound, an acid anhydride, an amino compound, and an imidazole compound. The content of the curing agent may be, for example, 0.5 parts by mass or more or 1.0 parts by mass or more, and may be 15 parts by mass or less or 10 parts by mass or less relative to 100 parts by mass of the resin.

The resin composition may further contain other components. The other components may be, for example, a curing accelerator (curing catalyst), a coupling agent, a wet dispersant, and a surface conditioner.

Examples of the curing accelerator (curing catalyst) include phosphorus curing accelerators such as tetraphenylphosphonium tetraphenylborate and triphenylphosphate, imidazole curing accelerators such as 2-phenyl-4,5-dihydroxymethylimidazole, and amine curing accelerators such as boron trifluoride monoethylamine.

Examples of the coupling agent include a silane-coupling agent, a titanate coupling agent, and an aluminate coupling agent. Examples of the chemical bonding group contained in these coupling agents include a vinyl group, an epoxy group, an amino group, a methacrylic group, and a mercapto group.

Examples of the wet dispersant include phosphoric acid ester salts, carboxylic acid esters, polyesters, acrylic copolymers, and block copolymers.

Examples of the surface conditioner include an acrylic surface conditioner, a silicone surface conditioner, a vinyl surface conditioner, and a fluorine surface conditioner.

### EXAMPLES

Hereinafter, the present invention will be specifically described with reference to Examples. However, the present invention is not limited to the following Examples.

### Example 1

Boron carbide particles having an average particle size (D50) of 26 μm were filled in a crucible made of carbon, and heated and pressurized according to a HIP method at 1800 °C and 196 MPa for 1.5 hours in a nitrogen gas atmosphere by a hot isostatic pressing apparatus (manufactured by Kobe Steel, Ltd.) to nitride the boron carbide particles, and boron carbonitride particles (B₄CN₄) were obtained. After 100 parts by mass of the obtained boron carbonitride particles and 150 parts by mass of boric acid (boric acid: 60 mass %) were mixed by a Henschel mixer, the mixture was filled in a crucible made of boron nitride and heated at a retention temperature of 2000 °C and 0.03 MPa in a normal-pressure nitrogen gas atmosphere for a retention time of 5 hours in a resistance heating furnace to obtain coarse particles. The coarse particles were crushed in a mortar for 10 minutes, and then classified with a nylon sieve having a sieve-mesh size of 175 μm. As a result, an aggregate of particles (powder) was obtained.

### Example 2

A powder was obtained in the same manner as in Example 1 except that: the amount of boric acid was changed to 100 parts by mass (50 mass % of boric acid).

### Example 3

A powder was obtained in the same manner as in Example 1 except that the amount of boric acid was changed to 81.8 parts by mass (45 mass % of boric acid).

### Comparative Example 1

A boron nitride powder was obtained in the same manner as in Example 1 except that boron carbide particles were nitrided by heating and pressurizing in a nitrogen gas atmosphere at 2000 °C and 0.85 MPa for 25 hours in a resistance heating furnace to obtain boron carbonitride particles.

### [X-Ray Diffraction Measurement]

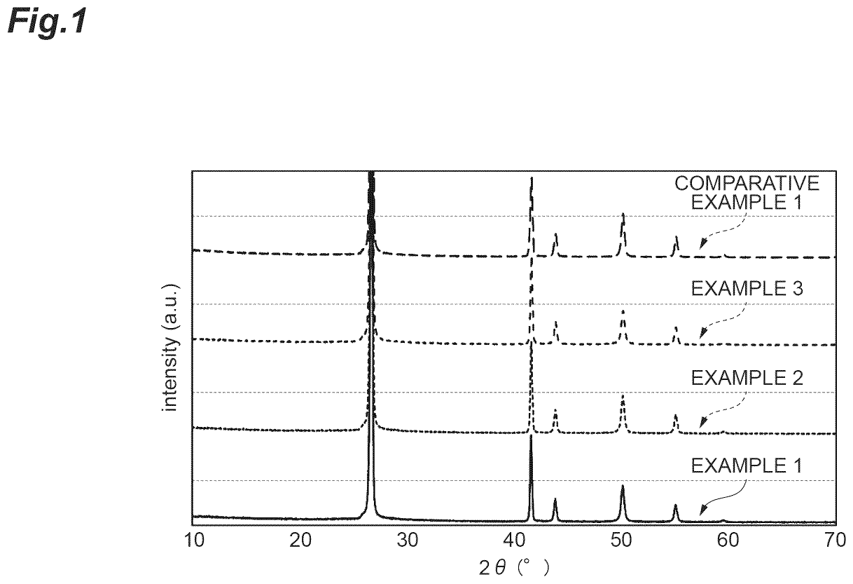

A part of the powder obtained in each of Examples was taken and subjected to X-ray diffraction measurement using an X-ray diffractometer (“ULTIMA-IV” manufactured by Rigaku Corporation). The X-ray diffraction measurement results of Examples and the X-ray diffraction measurement results of the boron nitride powder obtained as a comparative product in Comparative Example 1 are separately shown in FIG. 1. As is apparent from FIG. 1, only a peak derived from boron nitride was detected, and it was confirmed that a boron nitride powder was obtained in each of Examples.

### [Measurement of Differential Pore Volume of Boron Nitride Powder]

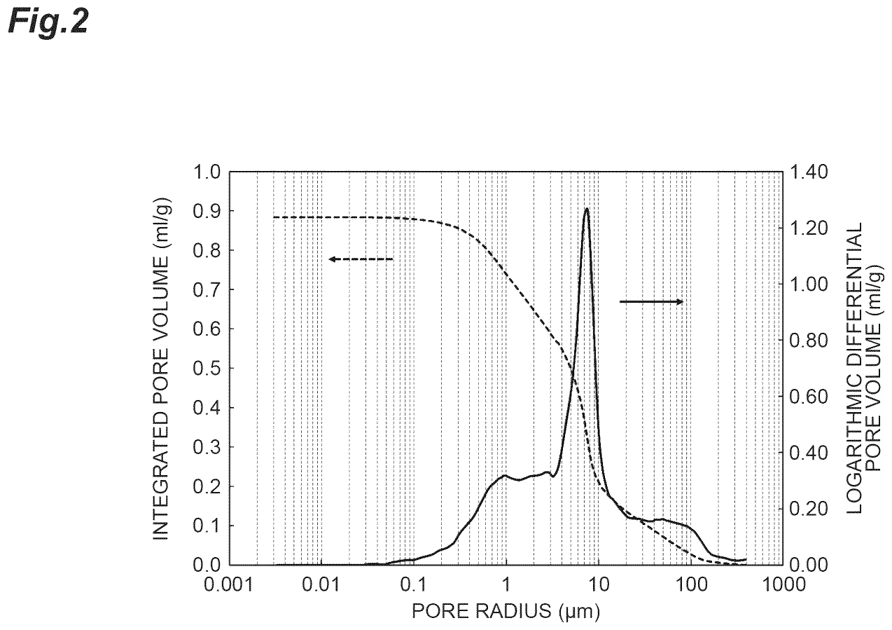

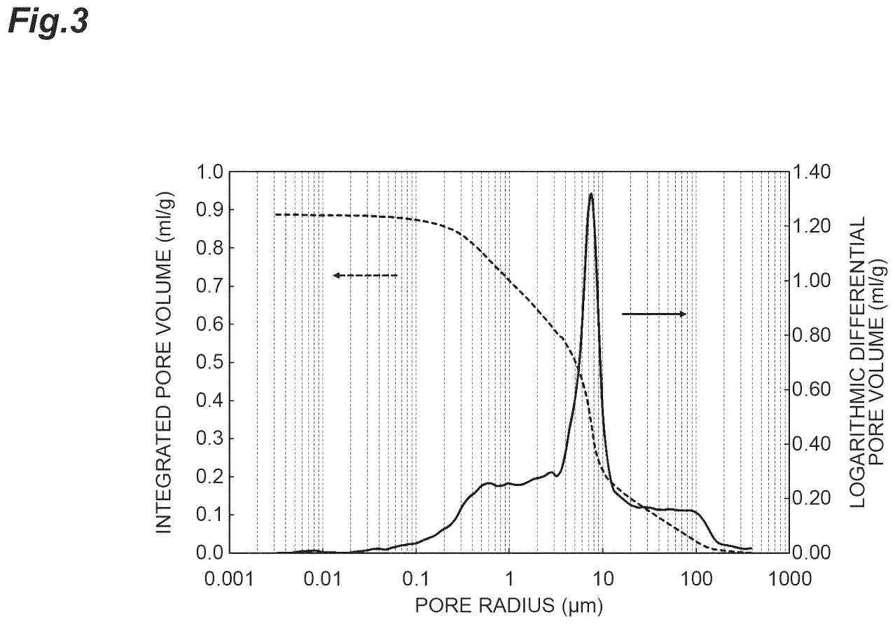

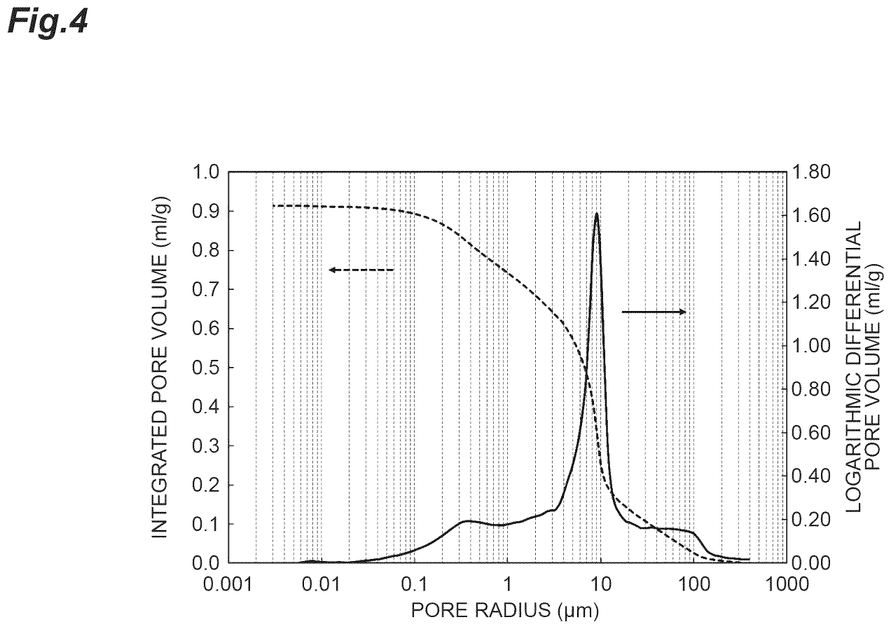

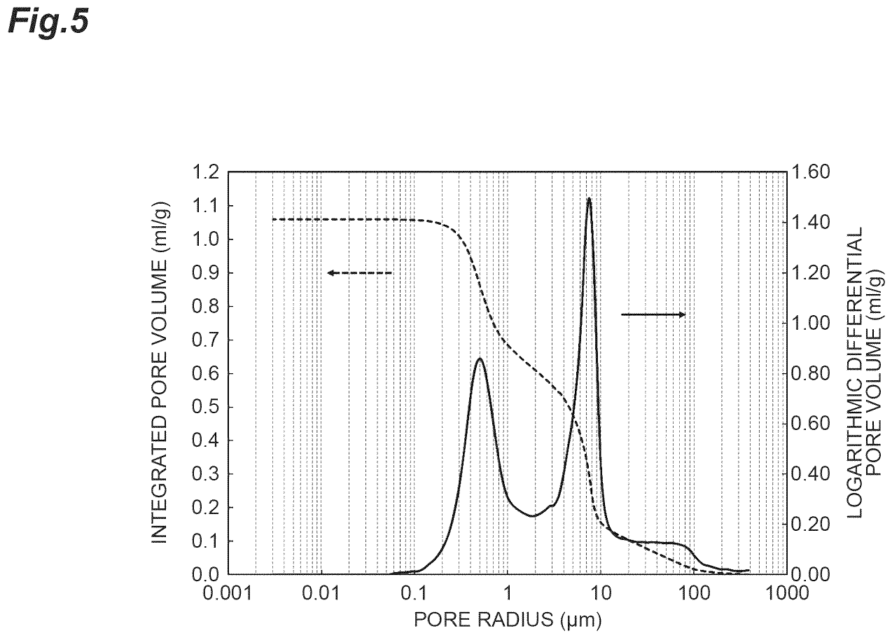

Each of the obtained boron nitride powders was subjected to measurement by a mercury porosimeter in accordance with the following procedure, and the differential pore volume with respect to the pore radius was measured. Autopore IV9500 manufactured by Shimadzu Corporation was used as a measuring apparatus, and a measuring cell for powder of 5 cc×1.1 cc was used. First, the differential pore volume corresponding to a pressure in the range of 0.40 to 60,000 psia was measured by a mercury porosimeter. At this time, the logarithmic value of pressure was plotted on the horizontal axis and the differential pore volume was plotted on the vertical axis to prepare a logarithmic graph. In the logarithmic graph, 130 pressure values at which a differential pore volume was measured were marked at equal intervals on the horizontal axis. Then, the pressure value was converted to the pore radius, and thereafter the measured differential pore volume with respect to the logarithmic value of the converted pore radius was plotted, and then the plots were connected by a straight line to obtain a differential pore volume curve with respect to the pore radius. The differential pore volume curves with respect to the pore radius of the boron nitride powders obtained in Examples 1 to 3 are shown in FIGS. 2 to 4, respectively, and the differential pore volume curves with respect to the pore radius of the boron nitride powder obtained in Comparative Example 1 is shown in FIG. 5. From the obtained differential pore volume curve, the pore radii R₁, R₂, and R₃, the differential pore volumes V₂ and V₃, the slopes a and b of the straight lines, the integrated pore volumes up to a pore radius of 1.2 μm, and the integrated pore volumes tip to a pore radius of 500 μm were calculated. The results are shown in Table 1. The bulk density of the boron nitride powder was calculated from the density (2.26 g/ml) of boron nitride particles and the integrated pore volume.

### [Measurement of Average Particle Size of Boron Nitride Powder]

The average particle size of the boron nitride powder was determined by a particle-size distribution measuring apparatus (“LS-13 320”, manufactured by Beckman Coulter, Inc.) in accordance with a laser diffraction scattering method and ISO 13320:2009. Note that samples were not homogenized before the measurement treatment and subjected to the measurement. In measuring the particle-size distribution, water was used as a solvent for dispersing the boron nitride powder, and hexametaphosphoric acid was used as a dispersant. At this time, a numerical value of 1.33 was used as the refractive index of water and a numerical value of 1.7 was used as the refractive index of the boron nitride particles. The results are shown in Table 1.

### [Measurement of BET Specific Surface Area of Boron Nitride Powder]

The BET specific surface area of boron nitride powder was measured using nitrogen gas in accordance with JIS Z 8830:2013, by a BET multipoint method. The results are shown in Table 1.

TABLE 1

| | Example | Example | Example | Comparative |
|---|---|---|---|---|
| | 1 | 2 | 3 | Example 1 |
| Pore radius R₁ [μm] | 0.11 | 0.06 | 0.04 | 0.12 |
| Pore radius R₂ [μm] | 0.96 | 0.61 | 0.39 | 0.51 |
| Differential pore | 0.32 | 0.26 | 0.19 | 0.86 |
| volume V₂ [ml/g] | | | | |
| slope a of straight line | 0.35 | 0.43 | 0.50 | 2.16 |
| Pore radius R₃ [μm] | 1.15 | 0.73 | 0.88 | 1.14 |
| Differential pore | 0.31 | 0.25 | 0.17 | 0.27 |
| volume V₃ [ml/g] | | | | |
| slope b of straight line | −0.05 | −0.08 | −0.04 | −0.94 |
| Integrated pore volume | 0.17 | 0.19 | 0.18 | 0.39 |
| [ml/g] up to pore | | | | |
| radius of 1.2 μm | | | | |
| Integrated pore volume | 0.91 | 0.89 | 0.88 | 1.05 |
| [ml/g] up to pore | | | | |
| radius of 500 μm | | | | |
| Bulk density [g/ml] | 0.75 | 0.75 | 0.74 | 0.67 |
| Average particle | 42.3 | 44.7 | 51.5 | 42.3 |
| size [μm] | | | | |
| BET specific surface | 2.93 | 3.42 | 3.52 | 4.37 |
| area [m²/g] | | | | |

### [Measurement of Thermal Conductivity]

Resin compositions were obtained by mixing 100 parts by mass of a naphthalene epoxy resin (HP4032 manufactured by DIC Corporation) and 10 parts by mass of an imidazole compound (2E4MZ-CN manufactured by SHIKOKU KASEI HOLDINGS CORPORATION) used as a curing agent, and subsequently mixing each of the boron nitride powders obtained in Example 1 and Comparative Example 1 so as to satisfy a filling rate of the boron nitride powder of 70 vol %. This resin composition was defoamed under vacuum at 500 Pa for 10 minutes, and applied onto a sheet made of PET with a thickness of 1.0 mm. Thereafter, press heating/pressurization was performed for 60 minutes at a temperature of 150 °C and a pressure of 160 kg/cm² to prepare a 0.5 mm sheet-like heat dissipation material. From the produced heat dissipation material, measurement samples having a size of 10 mm×10 mm were cut out and subjected to measurement of the thermal diffusivity A (m²/sec) by a laser flash method using a xenon flash analyzer (LFA447 NanoFlash manufactured by NETZSCH, K.K.). The specific gravity B (kg/m³) of the measurement samples was measured by the Archimedes method. The specific heat capacity C (J/(kg K)) of the measurement sample was measured by a differential scanning calorimeter (ThermoPlus Evo DSC8230 manufactured by Rigaku Corporation). Using these physical property values, the thermal conductivity H (W/(m·K)) was determined in accordance with the Formula: H=A×B×C. The thermal conductivity of the heat dissipation material prepared using the boron nitride powder obtained in Example 1 was 22 W/(m·K), whereas the thermal conductivity of the heat dissipation material prepared using the boron nitride powder obtained in Comparative Example 1 was 17 W/(m·K).

1. A boron nitride powder comprising boron nitride particles having pores, wherein
in a differential pore volume curve with respect to pore radius measured by a mercury porosimeter, within the range where the pore radius is 1.2 μm or less, the slope of a straight line connecting the point where the differential pore volume curve rises and the point where the differential pore volume reaches its maximum value is 0.8 or less.

2. The boron nitride powder according to claim 1, wherein an integrated pore volume in the pore-radius range of 1.2 μm or less is 0.2 ml/g or less.

3. The boron nitride powder according to claim 1, wherein the maximum value is 0.4 ml/g or less.

4. The boron nitride powder according to claim 1, wherein the maximum value is 0.1 ml/g or more.

5. A resin composition comprising the boron nitride powder according to claim 1 and a resin.
